(19) United States
(12) Patent Application Publication
(10) Pub. No.: US 2008/0155502 A1
(43) Pub. Date: Jun. 26, 2008

(54) METHOD AND PROCESS FOR HANDLING PARTIALLY TRANSLATED SCRIPTS

(75) Inventors: Belinda Y. Chang, Cary, NC (US); John R. Hind, Raleigh, NC (US); Robert E. Moore, Durham, NC (US); Brad B. Topol, Cary, NC (US); Jie Xing, Cary, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/615,049

(22) Filed: Dec. 22, 2006

(51) Int. Cl. G06F 9/44

(52) U.S. Cl. 717/115

(57) ABSTRACT

A method, article, and system to implement software that manages script execution, and more particularly to providing a method, article, and system for handling the output and translation of text strings. The scripting environment of the present invention can detect when the user may encounter text strings that have yet to be translated into the end-user's native language. Before executing the first target, the scripting environment can warn the user of the language discrepancy. Users may elect to interact with the scripts with text strings (1) in a combination of their native language and the primary language (typically English, but not limited thereto), entirely (2) hi their native language using machine translation to translate some text strings, or (3) in the primary language only.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to software that manages user interactions for a script generation, and more particularly to providing a method, article, and system for handling the output and translation of text strings.

2. Description of the Related Art

A common programming task is known as scripting, or connecting diverse preexisting components to accomplish a new related task. Languages which are suited to scripting are typically called scripting languages. Scripting languages have common properties including rapid development over efficiency of execution, and are often implemented with interpreters rather than compilers. Scripts are strong at communicating with program components written in other languages.

Scripts act as “glue” that puts several components together; and thus they are widely used for creating graphical user interfaces or executing a series of commands that might otherwise have to be entered interactively through a keyboard at the command prompt. A typical computer operating system offers some type of scripting language by default, widely known as a shell script language. Scripts are typically stored only in their plain text form (as ASCII) and interpreted, or compiled each time prior to being invoked.

Scripts often output vital information indicating the progress of the script to the user. In addition, scripts often require interaction with the user at runtime. The scripting environment often translates the text strings displayed by a script into multiple languages to allow for globalization. Scripts with such translated strings can then present instructions and other information to the user in the language identified by their locale. Products are translated into multiple languages to accommodate clients from all across the world. However, translations often take a while to produce. It is common practice for software producers to release fixes and enhancements to their products. The additional functionality may require that extra information be conveyed to the user and as a result, more strings may be added in order to enhance the interaction between the user and the script. One of the benefits of using scripts is that they are easy to edit. However, it is not a trivial process to translate strings. Typically, the turnaround time for translating strings is greater than the time required to modify a script. Waiting for a translation to occur could postpone the release date of a script. When a new release contains product fixes, the additional time needed to wait for a translation to be completed is not in the customer's best interests. In addition, it is possible that not all scripts in a release will encounter un-translated strings. Therefore, it is not optimal to hold back on a release when the user may not even use scripts that contain the newest un-translated strings.

However, the current industry practice with regards to new software releases for multiple language markets is to postpone shipping modified scripts, to revert to the primary language (typically English, but not limited thereto) for the entire script, to present the user with previously translated strings in combination with new strings in the primary language, or to provide machine translations for the new strings. In general, these options are not acceptable. Software support requires timely release of script updates. Users may prefer a partial or best-effort translation to format entirely in the primary language for consistency. In addition, having some strings un-translated may leave the user with a perception that there are defects in the software. Finally, the user should be warned that machine translation is not always accurate.

The present invention is directed to addressing, or at least reducing, the effects of, one or more of the problems set forth above, by providing a method, article, and system for utilizing the new strings in the primary language during the period where strings are still in the translation process. The method of the present invention allows users to choose among three different options:

### (1) Viewing original strings (that were previously translated) in their native language as determined by their locale while viewing the new additional strings in the primary language (typically English, but not limited thereto).

### (2) Viewing original strings in their native language while viewing the new additional strings in the native language with a machine translation from the primary language to the native language.

### (3) Viewing all the strings in the primary language.

### SUMMARY OF THE INVENTION

Embodiments of the present invention comprise a method for managing translation and presentation of text strings associated with scripts. The method comprises selecting a first script using a user interface, with the first script being selected from one or more scripts each containing a set of one or more keys that reference text strings comprised of characters that form words relating to a spoken language; and determining if the selected first script contains keys that reference text strings from the set of one or more text strings that have not been translated into the spoken language; wherein based on the determination, presenting a user with options relating to script translation and presentation via the user interface.

The determination if the script contains keys that reference text strings that have not been translated into the spoken language comprises analyzing targets containing keys that have the potential of being executed by the one or more scripts, and creating an index of the keys in the targets, if the index did not already exist, or if the one or more scripts has been modified prior to selecting a first script. The method of determining further comprises analyzing if the target containing the keys has undergone a change based on a last modified date of the target containing the keys, as well as if the index contains a key for a text string not in the one or more scripts, and concluding that the one or more scripts contains a key for a text string that has not been translated into the spoken language.

The method of determination of the present invention also involves maintaining a first and a second list. The first list indicates instances where all text strings referenced by keys in the selected first script have been translated into the spoken language; and the second list indicates instances where the user has to be warned in response to not all of the text strings referenced by keys in the selected first script having been translated into the spoken language. The determining further comprises referring to the first and second lists to decide if the selected script should be run as is, or if the user should be presented with the options on the user interface on how to manage the script translation and presentation. The first and second lists are cleared in response to the one or more scripts being modified. The determination process is only run if the one or more scripts have never been run for the locale of the user.

Based on the determination of the method of the present invention, the user is warned via the user interface that each of the one or more scripts may display to the user a text string that has not been translated into the user's spoken language. In addition, based on the determination, the user is presented with the following options: continuing with the first script for the user's locale and advising the user that certain text strings may be in a language that is different from the spoken language; using the spoken language with machine translation from the primary language to the spoken language for the one or more text strings that have not been formally translated; or presenting the user with the option of allowing all text strings in the first script to be in the primary language.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flowchart illustrating the progression of the script solution of an embodiment of the present invention.

FIG. 2 illustrates a system for practicing one or more embodiments of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method and system for integrating newly added, un-translated text strings with previously translated text strings. The scripting environment of the present invention can detect when the user may encounter text strings that have yet to be translated into the end-user's native language. Before executing the first target, the scripting environment can warn the user of the language discrepancy. Users may elect to interact with the scripts with text strings (1) in a combination of their native language and the primary language (typically English, but not limited thereto), entirely (2) in their native language using machine translation to translate some text strings, or (3) in the primary language only.

The present invention provides the user with the following advantages and benefits. Translations take time and scripts change relatively quickly, however the present invention allows the user to have access to the latest script changes without having to wait for additional text strings to be translated. The method provides the user the choice of which language option is most comfortable for them. In addition, translations of additional text strings can be added slowly over time and detected at runtime. During runtime, the script engine can determine if the text strings encountered are translated into a certain language.

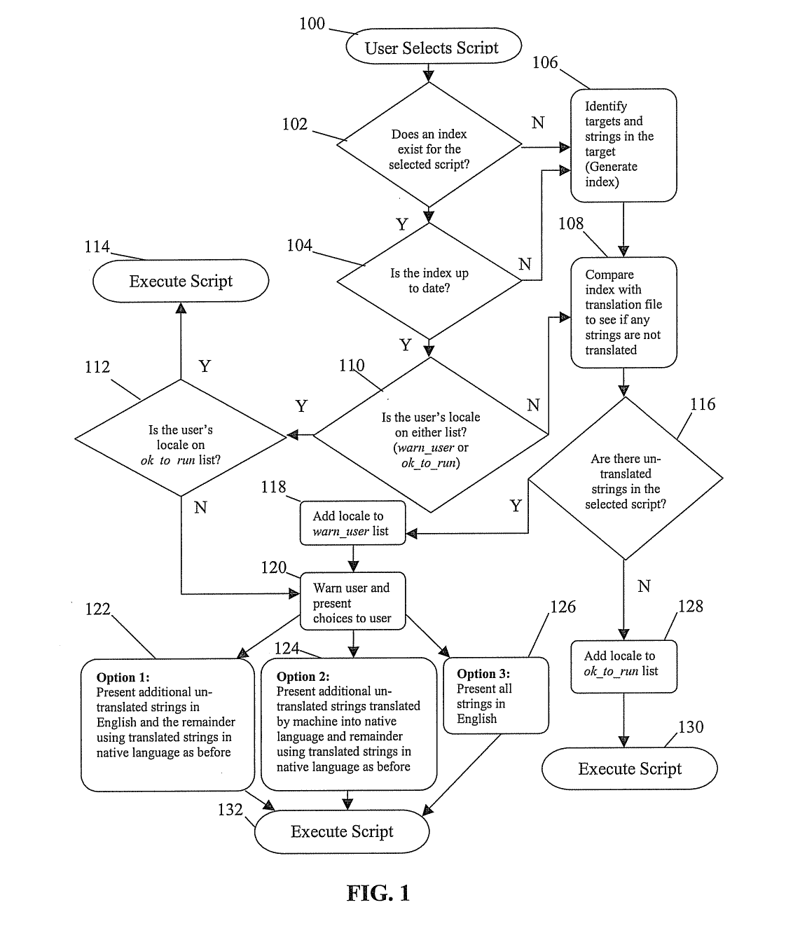

FIG. 1. illustrates the process for handling partially translated scripts according to an embodiment of the present invention. The user starts the process by selecting a script to run (100). In response to the user's choice, the script engine begins the process of determining whether the user will encounter strings that have yet to be translated into the language of the native locale. Based on the script selected, a program scans through the targets that could potentially be executed by the script. An index of the strings referenced by the keys in each target can be created automatically (106) if the index for the selected script does not exist (102). The index does not have to be created for each script run. Only when the translation file or the targets have been modified does the index need to be recreated.

Detecting whether the translation file has been modified is determined by examining the last modified date of the file (104). With regards to the targets, an assumption is made that when the XML document containing the target changes, it is possible that the target may have also changed. Changes to the index result when either the last modified date of the translation files or of the XML documents containing the targets in the script have a later date than the last modified date of the index. The engine can determine if any of the strings in the index are not in the translation file (108). If any text string in the index cannot be found in the file, the script contains a string that is not translated (116). This means that the script must warn (120) the user that they may encounter a text string that has yet to be translated into their native language. The lookup is only performed if a user has never run the script in the locale.

To reduce the overhead of performing the lookup each time, two persistent lists are maintained (110), which are called ok_to_run and warn_user. The list, ok_to_run, indicates the locales where all text strings referenced by the selected script are translated and the persistent list, warn_user, indicates the locales where the user has to be warned since not all text strings referenced by the selected script are translated into the native language. When a script is run, the user's locale is added to one of two lists: ok_to_run (128) if all text strings are translated in that locale and warn_user (118) if a text string is not translated into the native language. For subsequent runs, the script engine can refer to these two properties to determine if the user should be warned (until the index is no longer up-to-date). If the user's locale is on the ok_to_run list (112) the script is executed (114), or if there are no un-translated strings in the selected script (116), the script is added to the ok_to_run list (128) and the script is executed (130). When the index is updated, the two persistent lists, ok_to_run and warn_user, are cleared.

When it is determined that a script may display an un-translated string (116), the scripting environment outputs a message (120) to the user indicating that the script chosen has text enhancements. The scripting environment can indicate to the user that it is possible that the user may encounter text strings that have not been formally translated. Based on the user's input, certain execution paths may not be executed and it is possible that the user may not encounter a text string that has not been translated into their native language. Since this cannot be determined ahead of time, the user must be warned anyway. The user is presented (120) with three options to choose from: (1) continue with the script in the user's locale and certain text strings may be in a different language (122), (2) use the native language with machine translation from the primary language to the native language for text strings that have not been formally translated (124), or (3) allow all text strings in the script to be in the primary language (126). The user can choose what they feel most comfortable with and the script can continue displaying text strings (132) according to the user's choice.

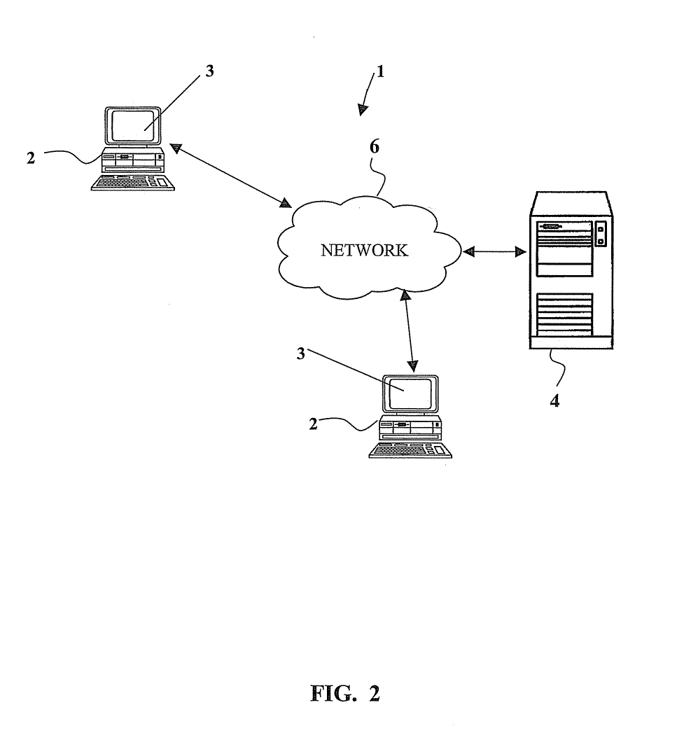

FIG. 2 is a block diagram of an exemplary system for implementing the script management and translation of the present invention and graphically illustrates how those blocks interact in operation. The system includes one or more computing/communication devices 2 coupled to a server system 4 via a network 6. Each computing/communication device 2 may be implemented using a general-purpose computer executing a computer program for carrying out the processes described herein. The computing/communication devices 2 may also be, but are not limited to, portable computing devices, wireless devices, personal digital assistants (PDA), cellular devices, etc. The computer program may be resident on a storage medium local to the computing/communication devices 2, or maybe stored on the server system 4. The server system 4 may belong to a public service provider, or to an individual business entity or private party. The network 6 may be any type of known network including a local area network (LAN), wide area network (WAN), global network (e.g., Internet), intranet, wireless or cellular network, etc. The computing/communication devices 2 may be coupled to the server system 4 through multiple networks (e.g., intranet and Internet) so that not all computing/communication devices 2 are coupled to the server system 4 via the same network. In a preferred embodiment, the network 6 is a LAN and each computing/communication device 2 executes a user interface application (e.g., web browser) to contact the server system 4 through the network 6. Alternatively, a computing/communication device 2 may be implemented using a device programmed primarily for accessing network 6 such as a remote client. A display means 3 is provided for the user to interact with the script management program.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for managing script translation and presentation, wherein the method comprises:
selecting a first script using a user interface, the first script being selected from one or more scripts referencing a set of one or more text strings comprised of characters that form words relating to a spoken language;
determining if the selected first script references text strings from the set of one or more text strings that have not been translated into the spoken language; and
in response to the determining, presenting a user with options relating to script translation and presentation via the user interface.

2. The method of claim 1, wherein:
the determining comprises analyzing targets referencing text strings that have the potential of being executed by the one or more scripts; and
creating an index of strings of the targets, if the index did not already exist, or if the one or more scripts has been modified prior to the selecting a first script.

3. The method of claim 2, wherein:
the determining further comprises analyzing if the target of referencing the strings has undergone a change based on a last modified date of the target of strings.

4. The method of claim 2, wherein:
the determining further comprises analyzing if the index contains a text string not referenced by the one or more scripts, and concluding that the one or more scripts references a text string that has not been translated into the spoken language.

5. The method of claim 1, further comprising:
warning a user via the user interface that each of the one or more scripts has the potential to display a text string that has not been translated into the spoken language.

6. The method of claim 1, wherein:
the determining is only run if the one or more scripts have never been nm in the locale of the user.

7. The method of claim 1, wherein:
the determining further comprises maintaining a first and a second list;
wherein the first list indicates instances where all text strings referenced by the selected first script have been translated into the spoken language; and
wherein the second list indicates instances where the user has to be warned in response to not all of the text strings referenced by the selected first script having been translated into the spoken language.

8. The method of claim 7, wherein:
the determining further comprises referring to the first and second lists to decide if the selected script should be run as is, or if the user should be presented with the options on the user interface on how to manage the script translation and presentation.

9. The method of claim 7, wherein:
the determining further comprises clearing the first and second lists in response to the one or more scripts being modified.

10. The method of claim 1, wherein:
based on the determining, presenting the user with the option of continuing with the first script for the user's locale and advising the user that certain text strings may be in a language that is different from the spoken language identified by the user's locale.

11. The method of claim 1, wherein:
based on the determining, presenting the user with the option of using the spoken language with machine translation from a primary language to the spoken language for the one or more text strings that have not been formally translated.

12. The method of claim 1, wherein:
based on the determining, presenting the user with the option of allowing all text strings in the first script to be in a primary language.

13. An article comprising machine-readable storage media containing instructions that when executed by a processor enable the processor to manage script translation and presentation in a system, wherein the system comprises computer servers, mainframe computers, and user interfaces, and wherein the user interfaces further comprise desktop computers, laptop computers, mobile computing devices, and mobile communication devices, the instructions for facilitating:
in response to a user selecting a script, determining if the selected script references text strings that have not been translated into the user's spoken language; and
based on the instruction determination, presenting the user with options on the user interface on how to manage the script translation and presentation.

14. The article of claim 13 wherein the instructions analyze targets potentially executable by the script, the instructions for further facilitating:
creating an index of strings referenced by the target, if the index did not already exist, or if the script has been modified prior to the user selecting the script;
determining if a target has undergone a change based on a last modified date of the target of strings; and
determining, in response to the index containing a text string not contained in a translation file for the user's locale, that the one or more scripts contain a text string that has not been translated into the user's spoken language.

15. The article of claim 13 wherein the instructions further facilitate warning the user via the user interface that the script may display a text string that has not been translated into the user's spoken language.

16. The article of claim 13 wherein the instructions further facilitate running the determining only if the script has never been run in the user's locale.

17. The article of claim 13 wherein the instructions facilitate maintaining a first and second list;
wherein the first list indicates instances where all strings referenced by the selected script have been translated into the user's spoken language;
wherein the second list indicates instances where the user has to be warned since not all of the strings in the selected script have been translated into the user's spoken language; and
wherein the instruction refers to the first and second lists to determine if the selected script should be run as is, or if the user should be presented with the options on the user interface on how to manage the script translation and presentation.

18. The article of claim 17 wherein the first and second lists are cleared in response to the one or more scripts being modified.

19. The article of claim 13 wherein the options further comprise the following user choices:
continuing with the script for the user's locale and advising the user that certain text strings may be in a different language;
using the user's spoken language with machine translation from the primary language to the user's spoken language for the one or more text strings that have not been formally translated; and
allowing all text strings in the script to be in the primary language;

20. A system for managing script translation and presentation,
wherein the system comprises computing devices and a network;
wherein the computing devices further comprise at least one of the following:
computer servers;
mainframe computers;
desktop computers; and
mobile computing devices; and
wherein at least one of the computing devices is configured to execute electronic software that manages the script translation and presentation; and
wherein the electronic software is resident on a storage medium in signal communication with at least one of the computing devices; and
wherein at least one of the computing devices is in signal communication with the network; and
wherein the network further comprises at least one of the following:
local area network (LAN);
wide area network (WAN);
a global network;
the Internet;
a intranet;
wireless networks; and
cellular networks.
